(19) United States
(12) Patent Application Publication
(10) Pub. No.: US 2009/0019677 A1
(43) Pub. Date: Jan. 22, 2009

(54) DEVICE FOR ATTACHING A CARRIER WIRE TO A MOUNTING WIRE

(75) Inventor: Josep Torres, Sant Joan de Vilatorrada (ES)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/916,456

(22) PCT Filed: Apr. 27, 2006
(86) PCT No.: PCT/EP06/03903

§ 371 Date: Dec. 4, 2007

(30) Foreign Application Priority Data
Jun. 23, 2005 (FR) 0506396

(51) Int. Cl. F16B 7/04; A01G 9/12; A01G 17/08; A44B 21/00; F16B 2/02; A01G 17/04

(52) U.S. Cl. 24/457; 24/487

(57) ABSTRACT

The quick-release device for attaching a vertical load bearing wire (32) to a supporting wire (30), which extends in a plane that is essentially perpendicular to the load bearing wire (32), is used for growing climbing plants along said load bearing wire (32). The device comprises a bracket (1) having clip-on fastening means for being suspended from the supporting wire (30), and holding means for assuring the suspension of the load bearing wire (32). The holding means have a female element provided in the carrier (1) and is capable of interacting with a male element fixed to the load bearing wire (32).

### BACKGROUND OF THE INVENTION

1. Field of the Invention

The invention relates to a quick-release device for attaching a vertical carrier wire to a mounting wire extending in a plane substantially perpendicular to the carrier wire. The device is intended for supporting the growth of climbing plants along said carrier wire.

Such a device serves, for example, to secure a carrier wire made of biodegradable material, along which tomato plants are to grow, to a mounting wire of the type of a metal wire.

2. Description of the Related Art

It is already known to employ a carrier wire made of biodegradable material to allow climbing plants to grow upward. These wires, disposed more or less vertically, are attached to a horizontal mounting wire, for example a metal wire, located at a distance from the ground. Some embodiments make use of several mounting wires disposed one above the other. As the carrier wires are set up, they are knotted directly to the mounting wire(s).

Securing a carrier wire with a knot takes considerable time, which increases the cost of labor. In installations involving a large number of carrier wires, setting up the wires becomes a very painstaking operation due to the large amount of manual effort required. In addition, the use of knots to secure the wires makes it impossible to precisely adjust the position of the attachment of the carrier wire along the mounting wire. This position instead depends solely on the exact location where the knot was made.

Finally, it will be appreciated that unfastening a large number of wires can very quickly become tiresome. The deterioration attendant on climatic conditions at the site results in the knots often being hard to undo when they were tied one or more seasons earlier.

### SUMMARY OF THE INVENTION

The object of the invention is to ameliorate all these disadvantages by proposing a quick-release device for attaching a vertical carrier wire to a supporting wire, by means of which the securing and unfastening of the carrier wire are facilitated and with which the position of the attachment of the carrier wire along the mounting wire is adjustable.

According to the invention, this object is achieved by a quick-release device which comprises a rider having clip-on hanging means so as to be suspended from the mounting wire, and retaining means to effect the suspension of the carrier wire. The retaining means comprises a female element provided in the rider and cooperates with a male element fixed to the carrier wire.

It will be readily understood that this type of attaching device serves to secure a carrier wire to a mounting wire quickly and effectively because it makes it possible to split the operation into two distinct steps: fitting the rider and the carrier wire together, and hanging the rider on the mounting wire. With this differentiation, each step can be made very simple via easy-to-use means such as clip-on attachment or the fitting together of a male element with a female element.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a front perspective view of the rider used in a first embodiment of an attaching device according to the invention;

FIG. 2 shows the rider of FIG. 1 from a rear perspective;

FIG. 3 is a perspective view of the first embodiment of the attaching device in the situation of holding a carrier wire;

FIG. 4 is a longitudinal sectional view of the device of FIG. 3;

FIG. 5 represents a second embodiment of an attaching device according to the invention in the situation of holding a carrier wire;

FIG. 6 is a perspective view of the rider used in FIG. 5 on leaving its production mold;

FIG. 7 is a perspective view of the rider of FIG. 6 in the situation of holding a carrier wire;

FIG. 8 is a longitudinal sectional view of the attaching device of FIG. 5; and

FIG. 9 is a cross sectional view of the attaching device of FIG. 5.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DESCRIPTION OF THE PRESENT INVENTION

The description that follows will briefly detail two preferred embodiments of an attaching device according to the invention. FIGS. 1 to 4 illustrate the first embodiment, and the other figures illustrate the second.

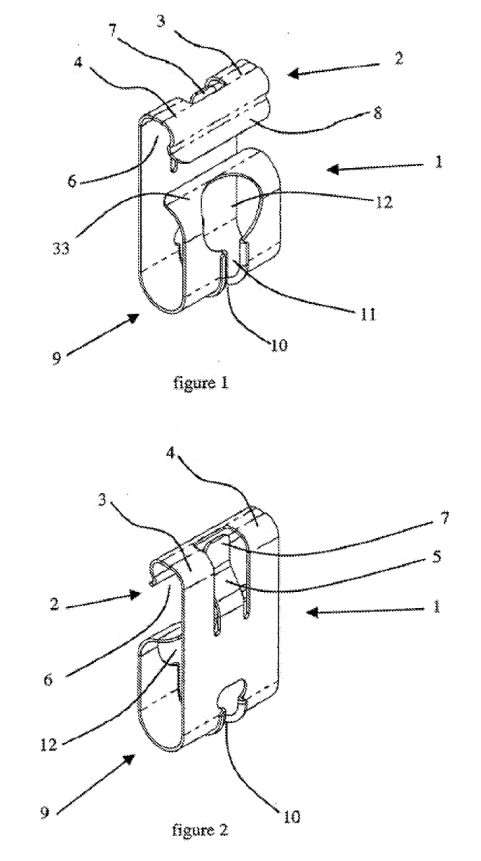

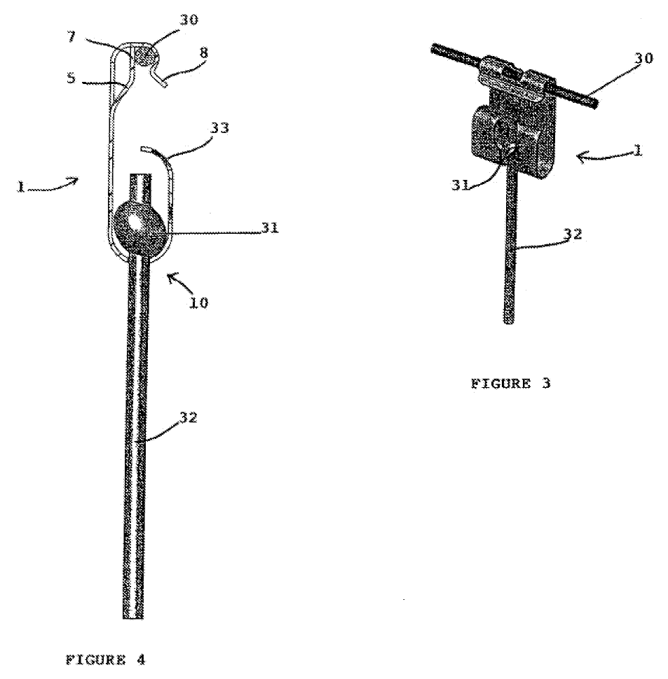

In reference to FIGS. 1 and 2, the first embodiment employs a rider produced by cutting and then bending a rectangular metal plate. In its upper part, it has a portion 2 comprising, on the one hand, two curved lateral tabs 3 and 4, and on the other hand, a flexible, elastic central tab 5 (FIG. 4). The two tabs 3 and 4 delimit an interior space 6 designed to receive the mounting wire 30 (visible in FIGS. 3 and 4). Tab 5 presents a double fold such that its distal end 7 is located in the center of interior space 6. The mounting wire 30 here is a metal wire of circular section. When mounting wire 30 is introduced into space 6, central tab 5 flexes to ensure that mounting wire 30 is held bearing against the inner faces of lateral tabs 3 and 4.

Thus, lateral tabs 3 and 4, in cooperation with central tab 5, constitute the clip-on hanging means for the rider 1 so that it can be suspended from the mounting wire 30 and its longitudinal position is adjustable. In addition, the free ends of the lateral tabs 3 and 4 are united by a pull flange 8 designed to facilitate the removal of the rider 1.

In its lower part, rider 1 has a female element comprising a curved portion 9 with an opening 10 in the bottom. The curved portion 9 forms a seat for a stop 31 provided along the carrier wire 32 (visible in FIGS. 3 and 4), which is designed to pass through the opening 10. This stop 31, which forms the male element, is often a knot made along the carrier wire 32, but can be produced by any known means. Furthermore, any known arrangement employing a male element provided along a wire and designed to cooperate with a female element may be contemplated.

As FIGS. 1 and 2 illustrate, curved portion 9 is provided with a slot 11 that extends through the entire thickness of said portion and joins opening 10 to a recess 12 provided near the free end 33 of curved portion 9. The dimensions of recess 12 are greater than those of the stop 31 of carrier wire 32, and the width of slot 11 is greater than the smallest dimension of the cross section of carrier wire 32. This particular arrangement makes it easier to set up the carrier wire 32 after the rider 1 has been hung on the mounting wire 30. That is, all the user has to do is to simultaneously feed the stop 31 of carrier wire 32 into the recess 12 and the carrier wire 32 into the slot 11, until the stop 31 comes to rest in the seat afforded by curved portion 9. The stop 31 is then braced against the contours of the opening 10 (FIGS. 3 and 4).

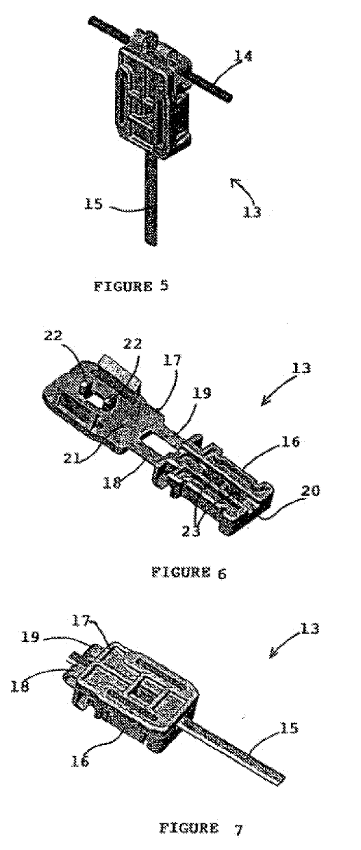

According to a second preferred embodiment of an attaching device according to the invention, and in reference to FIG. 5 et sequitur, the device comprises a rider 13 that is suspended from a mounting wire 14. In the particular example described here, the mounting wire 14 is a metal wire of circular section. According to the invention, the rider 13 is designed to hold a carrier wire 15 which in the present case is made of biodegradable material. It serves to guide climbing plants during their growth, for example for the commercial cultivation of tomato plants. Thus, mounting wire 14 is substantially horizontal, whereas carrier wire 15 is disposed vertically.

As FIGS. 6 and 7 illustrate, rider 13 comprises a main body 16 shaped as a rectangular parallelepiped, together with a globally rectangular cover 17. The height of main body 16 is much smaller than the dimensions of its bases. Nevertheless, the outer contours of main body 16 can be of any desired shape without departing from the scope of the invention. Main body 16 and cover 17 are connected to each other by two leaves 18 and 19 of reduced thickness made of a material having high plastic deformability. In use, main body 16 is designed to be suspended from mounting wire 14 by hanging means that will be detailed hereinafter. The cover 17 can be secured to body 16 with the aid of removable locking means that will be detailed hereinafter.

The preferred method of fabrication of rider 13 is injection molding. It is made of a biodegradable plastic, and FIG. 6 illustrates rider 13 on leaving the production mold. The two leaves 18 and 19 are flat, while main body 16 and cover 17 are coplanar. Leaves 18 and 19 constitute an area of articulation of the cover 17 relative to the main body 16. In practice, proceeding from the configuration of FIG. 6, the rider 1 is shaped manually into a deformable, U-shaped rider whose legs are respectively constituted by the body 16 and the cover 17. In this state, the area of articulation formed by leaves 18 and 19 enables the cover 17 to be moved away from or toward the main body 16.

As FIG. 6 indicates, a straight slot 20 is provided in the inner face of main body 16. It opens at its two ends onto the edge face of main body 16. Its width is sufficient for it to receive carrier wire 15 during use. The direction of slot 20 defines the longitudinal direction of main body 16.

In reference to FIG. 6, the two leaves 18 and 19 are parallel and are arranged such that the ends of each of them are joined respectively to main body 16 and to cover 17. They are separated from each other along the lateral direction by a sufficient distance to permit the passage of carrier wire 15. The lateral direction of main body 16 is defined as the direction defining the width of slot 20. The transverse direction is that which is simultaneously perpendicular to the longitudinal and lateral directions.

The empty space located between the walls of slot 20 and the inner face 21 of cover 17 defines a conduit for receiving carrier wire 15 during use. Since slot 20 is straight, the conduit is also globally straight, and its general direction coincides with that of slot 20.

In the example described, the axis of articulation of cover 17 relative to main body 16 that is provided by leaves 18 and 19 extends in the lateral direction of said body. This axis is therefore perpendicular to the general direction of the conduit.

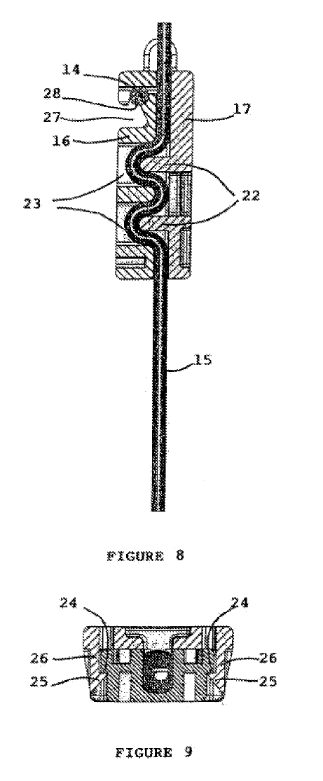

Projecting from the inner face 21 of cover 17 are two studs 22 which are intended to insert into slot 20 when cover 17 is secured on main body 16. Two transverse openings 23 are provided in the bottom of slot 20 and are spaced out along said slot. A stud 22 inserts into each of them when cover 17 is secured on main body 16. This results in a conduit comprising three baffles, visible in FIG. 8, and creates a clamp for carrier wire 15. The clamping means for clamping carrier wire 15 in the conduit are produced by the cooperation of the slot 20, the inner face 21 of cover 17, the studs 22 and the transverse openings 23. These clamping means serve to automatically ensure that carrier wire 15 is held in position while cover 17 is being secured on body 16.

This particular arrangement of the invention has several advantages. First, the carrier wire 15 is held in position in the conduit of the rider 13 in a particularly effective manner after the cover 17 has been secured on the main body 16. This is due to the fact that, by virtue of this embodiment, the friction generated between the walls of the conduit and the carrier wire 15 is very high because of the successive deflections imposed by the baffles. This is beneficial when a heavy load is applied (especially inadvertently) to the carrier wire 15, and helps to increase the mechanical strength of the attachment.

The other advantage lies in the fact that after the cover 17 has been secured on the main body 16, the carrier wire 15 can be subjected to high internal tension if necessary. This is because, when securing carrier wire 15, the user hangs main body 16 on mounting wire 14, places mounting wire [sic] 15 in slot 20 while holding it with one hand above mounting wire 14, and then secures cover 17 on main body 16. During the latter operation, the deflections imposed on carrier wire 15 by the baffles serve to increase the internal tension of carrier wire 15 over the tension that was imposed manually by the user during the securing process.

Turning now to FIG. 9, cover 17 is secured on main body 16 with the aid of removable locking means constituted by:
two shoulders 24 implemented on the edge face of main body 16, disposed on one and the other side of slot 20,
two pins 25 disposed opposite each other, each designed to cooperate with a respective shoulder 24.

The pins 25 are disposed in the upper part of a pair of elastic-return, flexible lateral faces 26 extending from the inner face 21 of cover 17. These locking means are only one possible embodiment: for example, it may be contemplated to provide only one shoulder 24 on the edge face of main body 16, it then being located in the upper part of said body, i.e., opposite leaves 18 and 19. Cover 17 is then equipped with only one pin 25.

In this second embodiment, it will be understood that the clamping means for clamping carrier wire 15 in the conduit passing through rider 13 constitute the means of retaining said wire to effect its suspension. The female element is the previously defined conduit provided with baffles, while the male element is the carrier wire itself, which is devoid of any stops.

The outer face of main body 16 has a recess 27, visible in FIG. 8, located in the upper part of said body. Recess 27 comprises a portion 28 whose inner diameter is slightly smaller than that of the mounting wire. Since the rider 13 is made of plastic having high plastic deformability, all of portion 28 is elastic to make it possible to clip body 16 onto mounting wire 14. Clip-on attachment would still be possible, however, if portion 28 merely comprised an elastic area.

The rider 13 can be fabricated by multi-point injection, in which case a material of high plastic deformability need be used only in the necessary areas (area of articulation of cover 17, and portion 28). In addition, a plastic material or any metallic material or the like can be used indifferently to produce riders 1 and 13. Finally, any embodiment of clip-on hanging means may be contemplated by one skilled in the art. This choice will depend primarily on the material used to fabricate the rider.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-15. (canceled)

16. A quick-release device adapted for attaching a vertical carrier wire to a mounting wire which extends in a plane substantially perpendicular to said carrier wire, said device intended for growing climbing plants along said carrier wire, said device comprising a rider having a clip-on hanging means for suspending the device from a said mounting wire; a retainer for suspending a said carrier wire, said retainer comprising a female element provided in the rider for cooperating with a male element fixed to the carrier wire.

17. The device of claim 16 wherein the hanging means comprises an elastic portion in the upper part of the rider to permit clip-on attachment to said mounting wire.

18. The device of claim 17 wherein the elastic portion comprises two lateral tabs, which are curved to define an interior space designed to receive the mounting wire, and a flexible, elastic central tab whose distal end is located in the center of the interior space, said central tab flexing, when the mounting wire is introduced into the space, to ensure that the mounting wire is held bearing against the inner faces of the lateral tabs.

19. The device of claim 18 wherein the free ends of the lateral tabs are united by a pull flange designed to facilitate the removal of the rider.

20. The device of claim 16 wherein the female element comprises a curved portion located in the lower part of the rider and forming a seat for a stop defining the said male element, said stop being provided along the carrier wire, which is designed to pass through an opening provided in the bottom of said curved portion.

21. The device of claim 20 wherein the curved portion is provided with a slot over its entire thickness, thus joining the opening with a recess provided near the free end of said curved portion, the dimensions of said recess being greater than those of the said stop of the said carrier wire and the width of the slot being greater than the smallest dimension of the cross section of the said carrier wire.

22. The device of claim 16 wherein the rider is made by cutting and then bending a metal plate.

23. The device of claim 16 wherein the rider comprises:
a main body adapted to be suspended from the said mounting wire by the hanging means and forming a first leg of the rider;
a cover configured as a second leg of the rider and adapted to be secured on the main body with the aid of removable locking means;
an area of articulation uniting the main body and the cover and enabling the cover to be moved toward or away from the main body;
a conduit passing through the rider, to receive the carrier wire; and
clamping means for clamping the carrier wire in the conduit, to automatically hold said wire in position as the cover is being secured on the main body.

24. The device of claim 23 wherein the area of articulation is an area of reduced thickness produced in a material having high plastic deformability.

25. The device of claim 24 wherein the axis of articulation of the cover relative to the main body extends in a direction perpendicular to the general direction of the conduit.

26. The device of claim 25 wherein the area of articulation is defined by two parallel leaves, arranged such that the ends of each of them are joined respectively to the main body and to the cover, the two leaves being separated from each other along the direction of the axis of articulation of the cover by a sufficient distance to permit the passage of the carrier wire.

27. The device of claim 23 wherein the clamping means for the carrier wire comprises:
a straight slot created in the inner face of the main body so as to open at both of its ends onto the edge face of the main body, said slot having a sufficient width to receive the carrier wire; and
at least one stud projecting from the inner face of the cover, designed to insert into the slot, when the cover is secured on the main body, to effect the clamping of the carrier wire.

28. The device of claim 27 wherein the conduit comprises three baffles created by:
two transverse openings made in the bottom of the slot of the main body and spaced out along said slot; and
two studs projecting from the inner face of the cover, each of them inserting into one of said openings when the cover is secured on the main body.

29. The device of claim 23 wherein the locking means for locking the cover on the main body comprises:
two shoulders provided on the edge face of the main body and disposed to one side and the other of the slot; and
two mutually oppositely arranged pins, each designed to cooperate with a shoulder and disposed in the upper part of a pair of elastic-return, flexible lateral faces extending perpendicularly from the inner face of the cover.

30. The device of claim 23 wherein the rider is made from a molded biodegradable plastic material.
